(19) United States
(12) Patent Application Publication
(10) Pub. No.: US 2010/0008409 A1
(43) Pub. Date: Jan. 14, 2010

(54) METHOD FOR CLOCK JITTER STRESS MARGINING OF HIGH SPEED INTERFACES

(75) Inventors: Brian J. Cagno, Tucson, AZ (US); Gregg S. Lucas, Tucson, AZ (US); Thomas S. Truman, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/169,770

(22) Filed: Jul. 9, 2008

(51) Int. Cl. H04B 17/00; H04B 1/38

(52) U.S. Cl. 375/221

(57) ABSTRACT

A method for clock jitter stress margining of high speed interfaces including generating a jittered clock signal via a clock signal generator of a high speed interface controller card, inputting the jittered clock signal to a control input of a looped-back port of the high speed interface controller card, inputting a test pattern signal to the looped-back port generated from a logic circuitry of the high speed interface controller card, receiving the test pattern signal to the logic circuitry from the looped-back port via the transmitter to the receiver, monitoring a bit error rate of the looped-back port by comparing the received test pattern signal to the inputted test pattern signal, and outputting a fail indication signal if the bit error rate is within a fail threshold.

### BACKGROUND

1. Field of the Invention

This invention relates generally to high speed computer interfaces, and particularly to a method for clock jitter stress margining of high speed interfaces.

2. Description of Background

Computer system storage devices, such as networked database systems, are used to store data for numerous purposes. For example, computer system storage devices are used in financial, goods and services, governmental, medical, and technological industries for local, national, and global applications. High speed interfacing to these storage devices is important to provide efficient access to store and retrieve data. However, high speed interfaces, such as controller cards, need to be tested (e.g., during manufacturing) to ensure proper, error-free operation when put in service in storage devices. Testing of high speed interfaces is usually performed by transmitting test pattern signals through components of the interface and monitoring the signals for the introduction of errors as a result of malfunctions, failures, etc. of the components. As the transmission speed capability of high speed interfaces increases and the error rate specifications decrease (i.e., specifying fewer errors per bits transmitted), testing of high speed interfaces becomes more complex and time consuming. For example, many test pattern signals of various types may be needed to screen for various types of performance defects. Therefore, a testing method for high speed interfaces is desirable that provides improved test coverage in reduced time durations.

### SUMMARY

A method for clock jitter stress margining of high speed interfaces is provided. An exemplary embodiment of the method includes generating a jittered clock signal via a clock signal generator of a high speed interface controller card, inputting the jittered clock signal to a control input of a looped-back port of the high speed interface controller card, inputting a test pattern signal to the looped-back port generated from a logic circuitry of the high speed interface controller card, receiving the test pattern signal to the logic circuitry from the looped-back port via the transmitter to the receiver, monitoring a bit error rate of the looped-back port by comparing the received test pattern signal to the inputted test pattern signal, and outputting a fail indication signal if the bit error rate is within a fail threshold.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computer storage device that is configured for clock jitter stress margining of high speed interfaces.

FIG. 2 is a block diagram illustrating an example of a high speed interface controller card of the exemplary computer storage device of FIG. 1 that is configured for clock jitter stress margining of high speed interfaces.

FIG. 3 is a flow diagram illustrating an example of a method for clock jitter stress margining of high speed interfaces, which is executable, for example, on the exemplary computer storage device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a method for clock jitter stress margining of high speed interfaces is provided. In accordance with such exemplary embodiments, an effective method to test high speed interfaces is provided that offers improved test coverage in reduced time durations.

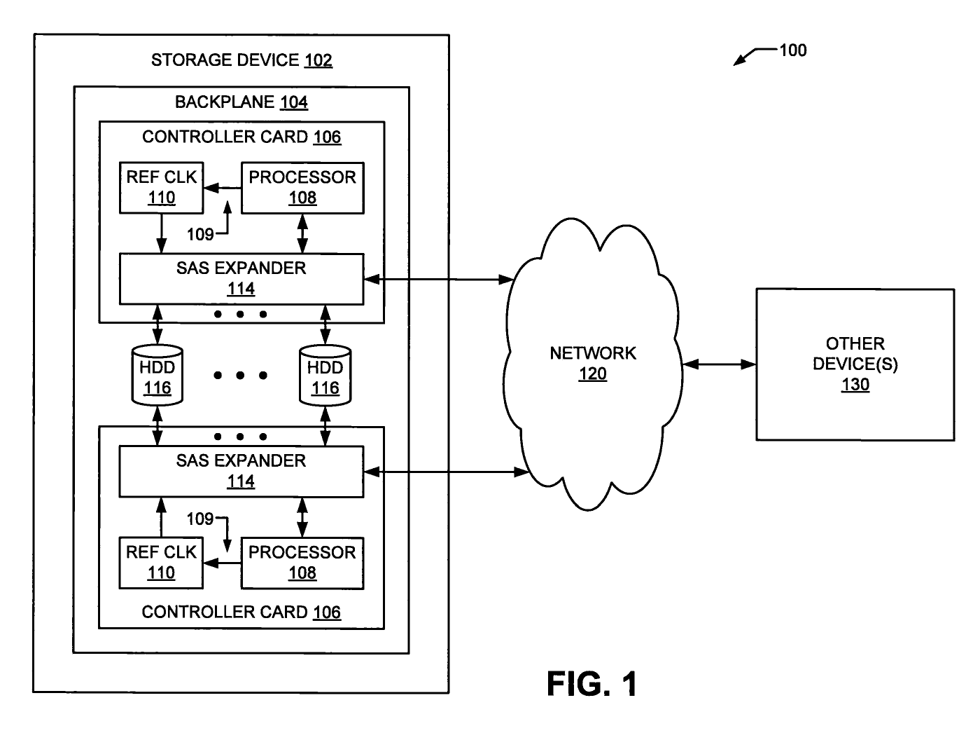

Turning now to the drawings in greater detail, wherein like reference numerals indicate like elements, FIG. 1 illustrates an example of a computer system 100 including an exemplary computer storage device (“storage device”) 102 configured for clock jitter stress margining of high speed interfaces. In addition to storage device 102, exemplary computer system 100 includes network 120 and other device(s) 130, and may include one or more wide area networks (WANs) and/or local area networks (LANs) such as the Internet, intranet(s), and/or wireless communications network(s). Other device(s) 130 may include one or more computing devices, e.g., one or more server devices, client device, other storage devices, etc. Storage device 102 and other device(s) 130 are in communication via network 120, e.g., to communicate data between them.

Exemplary storage device 102 includes one or more backplanes 104, which provide a connection interface for one or more high speed interface controller cards (“controller card”) 106 to storage device 102. Controller card 106 includes processor 108, which is in communication with reference clock signal generator (“reference clock”) 110 (via control interface/input 109) and serial attached (“SA”) small computer system interface (“SCSI”) port expander (“SAS expander”) 114. Reference clock 110 is in communication with a clock signal generator (not shown) that is, e.g., included in SAS expander 114. SAS expander 114 is in communication with one or more hard disk drives (“HDD”) 116. Controller card 106 provides a high speed interface (e.g., via SAS expander 114) with HDD 116, network 120, and/or other device(s) 130.

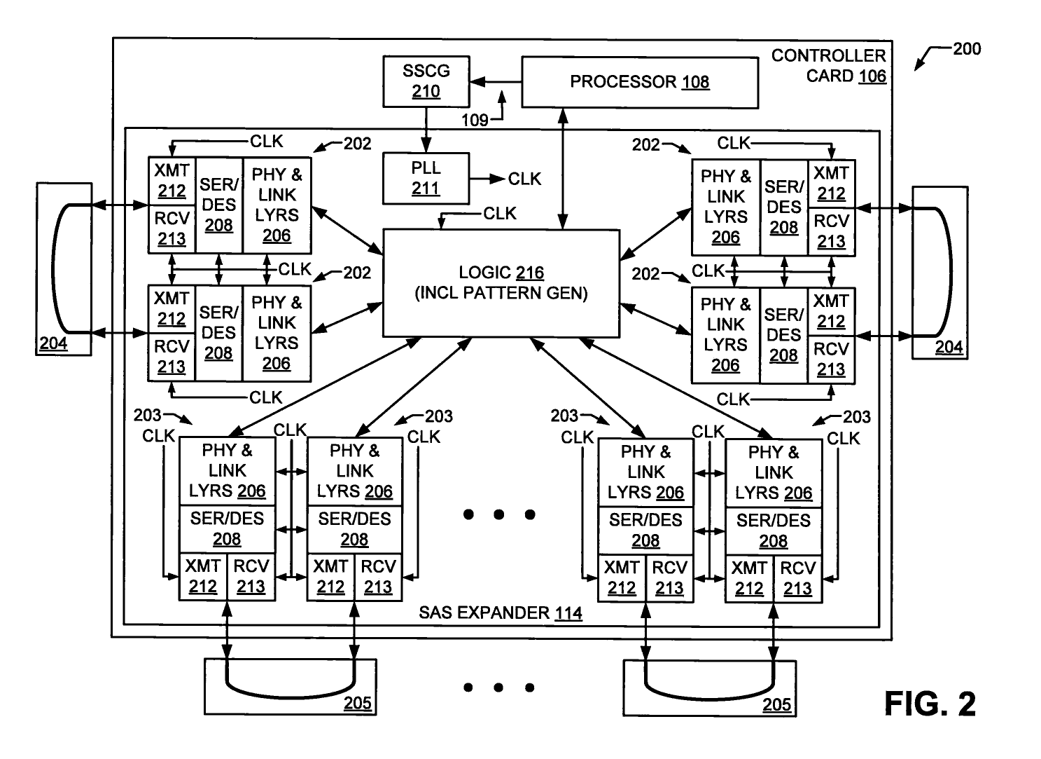

FIG. 2 is an example of a high speed interface controller card configuration 200 that is configured for clock jitter stress margining of high speed interfaces. Exemplary configuration 200 includes controller card 106 introduced with respect to storage device 102 in FIG. 1. In accordance with some exemplary embodiments, reference clock 110 is implemented by a spread spectrum clock signal generator (“SSCG”) 210, which is in communication with a clock signal generator that is implemented by a phase lock loop circuit (“PLL”) 211. In that regard, SSCG 210 and PLL 211 can be collectively considered as the “clock signal generator” in such embodiments, which generates a clock signal (“CLK” in FIG. 2) for normal operation and testing operation of controller card 106. SSCG 210 is configured to input a spread spectrum reference clock signal to PLL 211 with a frequency spread that causes PLL 211 to generate a jittered clock signal. As known, a jittered clock signal has a varying rising edge and/or falling edge with respect to time that leads or lags the rising edge and/or falling edge respectively of a normal or ideal clock signal and, as a result, has a varying unit interval or minimum interval between condition change of the clock signal (e.g., between logic-0 and logic-1). SSCG 210 may, e.g., be a variable or programmable spread spectrum clock signal generator (or “clocking module”) whose frequency spread can be varied, e.g., in response to control input 109 from processor 108. For example, SSCG 210 may be controlled by processor 108 to generate a reference clock signal with little or no frequency spread during normal operation of controller card 106 to generate a normal clock signal (e.g., with a unit interval that is greater than or equal to the specification unit interval of controller card 106). While, during testing operation, SSCG 210 may be controlled by processor 108 to generate a reference clock signal with a frequency spread that causes PLL 211 to generate a jittered clock signal with a unit interval that facilitates efficient testing (e.g., that is less than the specification unit interval of controller card 106).

As discussed above, controller card 106 also includes SAS expander 114. In some exemplary embodiments (e.g., as illustrated in FIG. 2), SAS expander 114 includes port circuitry (“port”) 202, 203. Port 202 may be a host port that can connect to other devices, such as other controller cards 106, networks 120, or other device(s) 130. Port 203 may be a device port that can connect to HDD 116 or other storage media. Ports 202, 203 include physical and link layers 206, serializer/deserializer (“SER/DES”) 208, transmitting circuit (“transmitter”) 212, and receiving circuit (“receiver”) 213, which are components used in high speed interfaces. One or more of these components of ports 202, 203 may include a clock input (“CLK”) that is in communication with PLL 211 for operation according to the clock signal. Ports 202, 203 are configured as looped-back ports by connecting them via loop-back connections 204, 205. Loop-back connections 204, 205 are used for configuration of high speed interfaces, e.g., for testing during manufacturing (e.g., prior to normal operation). For example, loop-back connection 204 may be a functional card test (“FCT”) cable wrap card and loop-back connection 205 may be an FCT connector wrap card. Loop-back connection 204, 205 connects transmitter 212 to receiver 213, and such loop-back connection may have various configurations. For example, loop-back connection 204, 205 may connect transmitter 212 of port 202, 203 to receiver 213 of port 202, 203 respectively as depicted. However, other loop-back configurations may be implemented in accordance with exemplary embodiments.

Ports 202, 203 are in communication with logic circuitry (“logic”) 216, which includes pattern generating logic circuitry and may also include a clock input (“CLK”) that is in communication with PLL 211. During normal operation, data signals are communicated between logic 216 and ports 202, 203, and during testing operation, test pattern signals are communicated between logic 216 and ports 202, 203. Logic 216 is in communication with processor 108, and processor 108 may initiate test pattern generation from logic 216 and jittered clock signal generation from PLL 211 via SSCG 210 during testing operation. Logic 216 (and/or processor 108) may monitor the looped-back transmission of test pattern signals from looped-back ports 202, 203 to monitor the bit error rate performance (e.g., number of bit errors per number of bits transmitted) of ports 202, 203. Furthermore logic 216 (and/or processor 108) may output a fail indication signal and/or a pass indication signal depending on the monitored bit error rate of ports 202, 203. An exemplary operation of exemplary configuration 200 will be described below.

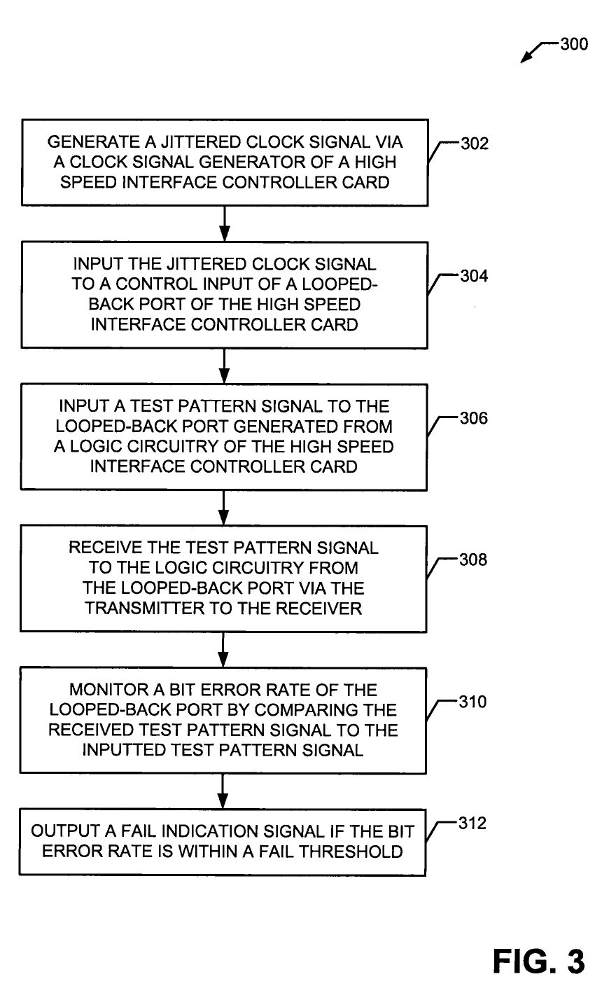

FIG. 3 illustrates an example of a method 300 for clock jitter stress margining of high speed interfaces, which is executable, for example, on the exemplary storage device 102 of FIG. 1 (e.g., as a computer program product). Exemplary method 300 also describes an exemplary operation of exemplary configuration 200. In block 302, a jittered clock signal is generated via a clock signal generator (e.g., PLL 211) of a high speed interface controller card (e.g., controller card 106). The jittered clock signal has a unit interval that is less than a specification unit interval of the high speed interface controller card. For example, the unit interval of the jittered clock signal may be 75% of the specification unit interval. In some embodiments, the jittered clock signal is generated by inputting a spread spectrum reference clock signal to a phase lock loop circuit (e.g., PLL 211) from a spread spectrum clock generator (e.g., SSCG 210). The spread spectrum reference clock signal has a frequency spread that causes the phase lock loop circuit to generate the jittered clock signal with a unit interval that is less than the specification unit interval of the high speed interface controller card.

In block 304, the jittered clock signal is input to a control input of a looped-back port (e.g., port 202, 203) of the high speed interface controller card. For example, the jittered clock signal is input to the transmitter and/or receiver of the looped-back port as depicted in FIG. 2. In block 306, a test pattern signal is input to the looped-back port that is generated from a logic circuitry (e.g., logic 216) of the high speed interface controller card. The jittered clock signal causes the looped-back port to transmit the test pattern signal at the unit interval of the jittered clock signal, which thereby causes a stress margining of the looped-back port that facilitates improved test coverage in reduced time durations. In block 308, the test pattern signal is received by the logic circuitry from the looped-back port via the transmitter to the loop-back connection to the receiver. That is, the test pattern signal that is input to the looped-back port is output back to the logic circuitry via the loop-back path from the transmitter to the receiver of the looped-back port.

In block 310, a bit error rate of the looped-back port is monitored via the logic circuitry (and/or the processor), e.g., by comparing the received test pattern signal to the inputted test pattern signal. In block 312, a fail indication signal is output via the logic circuitry (and/or the processor) if the bit error rate is within a fail threshold. In some embodiments, a pass indication signal may be output via the logic circuitry (and/or the processor) if the bit error rate is within a pass threshold. Depending on the operating specification of the high speed interface, a fail threshold may be a bit error rate of greater than 10⁻¹², and a pass threshold may be a bit error rate that is less than or equal to 10⁻¹². The fail indication signal and/or pass indication signal may cause other actions, such as an audio, visual, textual, etc. user notification.

Exemplary computer system 100 and storage device 102 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary computer system 100 and storage device 102, execution of the flow diagram blocks may be implemented with other hardware and/or software architectures that provide the same features, functions, etc. in accordance with exemplary embodiments of the invention.

Exemplary embodiments of the invention can be part of a design for an integrated circuit chip. This chip design can be created in a graphical computer programming language and stored in a computer storage medium (such as a disk, tape, physical hard drive, or virtual hard drive, such as in a storage access network). If the chip designer does not fabricate chips or the photolithographic masks used to fabricate chips, the designer may transmit the resulting design by physical means (e.g., by providing a copy of the storage medium storing the design) or electronically (e.g., through the Internet) to the corresponding entity, directly or indirectly. The stored design can then be converted into an appropriate format (e.g., GDSII) for the fabrication of photolithographic masks, which typically include multiple copies of the chip design to be formed on a wafer. The photolithographic masks can be utilized to define areas of the wafer (and/or the layers thereon) to be etched or otherwise processed to fabricate chips.

The resulting integrated chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has surface interconnections and/or buried connections). In any case, the chip is then integrated with other chips, discrete circuit elements, and/or other signal processing devices as part of either (a) any intermediate product, such as a motherboard, or (b) an end product. The end product can be any product that includes integrated circuit chips, ranging from toys and other low-end applications to advanced computer products having a display, a keyboard, or other input device, and a central processor.

Exemplary embodiments of the invention can also be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method for clock jitter stress margining of high speed interfaces, comprising:
generating a jittered clock signal via a clock signal generator of a high speed interface controller card, wherein the jittered clock signal has a unit interval that is less than a specification unit interval of the high speed interface controller card;
inputting the jittered clock signal to a control input of a looped-back port of the high speed interface controller card, wherein the looped-back port comprises a transmitter in communication with a receiver via a loop-back connection;
inputting a test pattern signal to the looped-back port generated from a logic circuitry of the high speed interface controller card, wherein the jittered clock signal causes the looped-back port to transmit the test pattern signal at the unit interval of the jittered clock signal thereby causing a stress margining of the looped-back port;
receiving the test pattern signal to the logic circuitry from the looped-back port via the transmitter to the loop-back connection to the receiver;
monitoring a bit error rate of the looped-back port via the logic circuitry by comparing the received test pattern signal to the inputted test pattern signal; and
outputting a fail indication signal via the logic circuitry if the bit error rate is within a fail threshold.

2. The method of claim 1, wherein:
the clock signal generator comprises a spread spectrum clock generator in communication with a phase lock loop circuit; and
generating a jittered clock signal comprises inputting a spread spectrum reference clock signal to the phase lock loop circuit from the spread spectrum clock generator, wherein the spread spectrum reference clock signal has a frequency spread that causes the phase lock loop circuit to generate the jittered clock signal having the unit interval that is less than the specification unit interval of the high speed interface controller card.

3. The method of claim 1, wherein the high speed interface controller card comprises a serial attached small computer system interface port expander that includes the looped-back port.
